(19) United States
(12) Patent Application Publication
(10) Pub. No.: US 2007/0294596 A1
(43) Pub. Date: Dec. 20, 2007

(54) INTER-TIER FAILURE DETECTION USING CENTRAL AGGREGATION POINT

(76) Inventors: Thomas R. Gissel, Apex, NC (US); Gennaro A. Cuomo, Cary, NC (US); William T. Newport, Rochester, MN (US); Barton C. Vashaw, Apex, NC (US)

Correspondence Address: HOFFMAN WARNICK & DALESSANDRO LLC, 75 STATE ST, 14TH FLOOR, ALBANY, NY, 12207, US

(21) Appl. No.: 11/419,602

(22) Filed: May 22, 2006

(51) Int. Cl. G06F 11/00

(52) U.S. Cl. 714/48

(57) ABSTRACT

The present invention provides inter-tier failure detection using a central aggregation point. A method in accordance with an embodiment of the present invention includes: performing intra-tier failure detection in a first tier of a multi-tier system; providing a failure status to a central aggregation point in the first tier; and communicating the failure status inter-tier to a central aggregation point of a second tier of the multi-tier system.

### BACKGROUND OF THE INVENTION

1. Field of the Invention

The present invention generally relates to failure detection, and more specifically relates to inter-tier failure detection using a central aggregation point.

2. Related Art

Components in one tier of a multi-tier system frequently need to know about the availability of components in another tier. It would be ideal if such knowledge could be communicated quickly and conveniently, with minimum inter-tier traffic, and without necessarily requiring both tiers to run the same protocol internally.

There are currently two predominant ways in which inter-tier heterogeneous component failures are detected: Transmission Control Protocol (TCP) KeepAlive time-out and heartbeating. Both of these failure detection schemes have advantages and disadvantages.

Using TCP KeepAlive as way to detect inter-tier heterogeneous component failure has the advantage of minimizing inter-tier traffic by utilizing data connections for failure detection. Unfortunately, since TCP KeepAlive parameters are system wide, tuning TCP KeepAlive for a specific component essentially makes the entire system component specific. Another negative to TCP KeepAlive is that failure is detected on a per connection basis, such that each connection has to time-out and the similarities between the connections are ignored. Another, noteworthy problem with using TCP KeepAlive as a failure detection mechanism is that the TCP tuning parameters are different for each system, making it notoriously difficult to properly configure. Further, because TCP KeepAlive is configured by a cascading set of timers, it is often not possible to set the values low enough to achieve the desired failover time.

Heartbeating is a popular alternative to TCP KeepAlive for inter-tier component failure detection, and is significantly different from TCP KeepAlive. Classical heartbeating typically involves using a non-data connection specifically designed to determine the inter-tier component status between two heterogeneous components. Heartbeating has several advantages over TCP KeepAlive. First, since the connection is built for the sole purpose of heartbeating, the heartbeating mechanism can be more sophisticated than a series of time-outs. Second, the heartbeat connection is usually component specific, so several components may have different heartbeat settings on the same system. Third, a heartbeat failure is component global so if the heartbeat fails, the entire component is notified of the failed component's status failure. Finally, since the connection is component specific, the connection's configuration can appear uniform across heterogeneous environments.

Although heartbeating does have the aforementioned advantages over TCP KeepAlive, there are several disadvantages. For instance, the most obvious disadvantage is that inter-tier traffic is necessarily increased because non-data connections are used. Also, because the heartbeat is component specific, there can be many heartbeat connections between the tiers. Another disadvantage involves the higher complexity of heartbeat connections.

As mentioned above, since a heartbeat connection's sole purpose is to perform heartbeating, the intelligence and sophistication of the connection can be increased. However, the higher the sophistication and intelligence the greater the knowledge the tiers must have of each other and thus the more tightly bound they become. Such tight binding increases the development complexity of the heartbeat component and, more significantly, can cause problems and even incompatibility as the products diverge from their original binding point. Thus, a heartbeat connection can either be architected generically, which decreases its accuracy and binding, or can be designed with a high degree of sophistication, which necessarily increases binding.

### SUMMARY OF THE INVENTION

The present invention provides inter-tier failure detection using a central aggregation point. In particular, the invention employs intelligent component specific heartbeating utilizing a central aggregation point for intra-tier failure detection. The component availability status is communicated via the central aggregation point across tiers, inter-tier, to other component clusters.

The present invention offers several improvements over inter-tier heartbeating and TCP KeepAlive. For instance, as mentioned above, classical inter-tier heartbeating consumes inter-tier bandwidth, which can be a scarce resource, beyond the required data connections. The present invention, however, removes the requirement to maintain heartbeating non-data communication inter-tier. Instead it uses intra-tier heartbeating and communicates status changes only when needed to the other tiers.

The present invention also solves the generic but flexible heartbeating versus sophisticated but component bound heartbeating dilemma described above. The heartbeating mechanism of the present invention only interacts with one component type so it can have, and utilize, detailed knowledge of the component without danger of unwanted lock-in. Contrastingly, classical heartbeating must interact with several different component types so it must be created in generic way or incur problems associated with inter-component binding.

A first aspect of the present invention is directed to a method for failure detection, comprising: performing intra-tier failure detection in a first tier of a multi-tier system; providing a failure status to a central aggregation point in the first tier; and communicating the failure status inter-tier to a central aggregation point of a second tier of the multi-tier system.

A second aspect of the present invention is directed to a system for failure detection, comprising: a system for performing intra-tier failure detection in a first tier of a multi-tier system; a system for providing a failure status to a central aggregation point in the first tier; and a system for communicating the failure status inter-tier to a central aggregation point of a second tier of the multi-tier system.

A third aspect of the present invention is directed to a program product stored on a computer readable medium for failure detection, the computer readable medium comprising program code for: performing intra-tier failure detection in a first tier of a multi-tier system; providing a failure status to a central aggregation point in the first tier; and communicating the failure status inter-tier to a central aggregation point of a second tier of the multi-tier system.

A fourth aspect of the present invention is directed to a method for deploying an application for failure detection, comprising: providing a computer infrastructure being operable to: perform intra-tier failure detection in a first tier of a multi-tier system; provide a failure status to a central aggregation point in the first tier; and communicate the failure status inter-tier to a central aggregation point of a second tier of the multi-tier system.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative multi-tier system including inter-tier failure detection using a central aggregation point in accordance with an embodiment of the present invention.

FIG. 2 depicts an illustrative sample runtime sequence illustrating the interaction of the components in FIG. 1 in accordance with an embodiment of the present invention.

FIG. 3 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

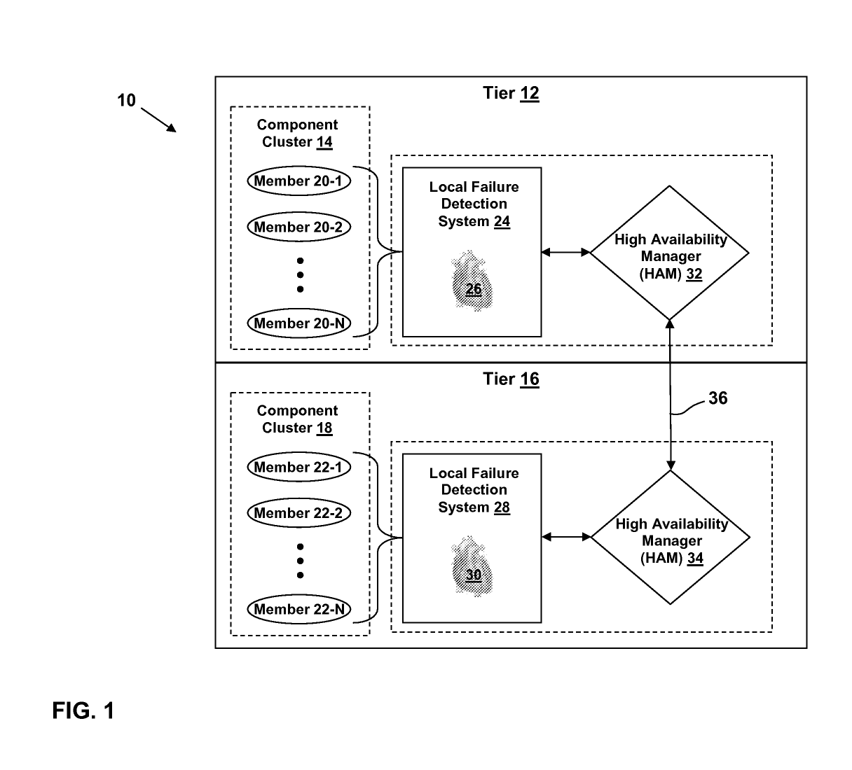

An illustrative multi-tier system 10 employing a failure detection methodology in accordance with an embodiment of the present invention is depicted in FIG. 1. In this example, the multi-tier system 10 comprises a first tier 12 including a homogeneous component cluster 14 and a second tier 16 including a homogeneous component cluster 18. The component cluster 14 in the tier 12 includes a plurality of members 20-1, 20-2, . . . , 20-N (e.g., web application servers). Similarly, the component cluster 18 in the tier 16 includes a plurality of members 22-1, 22-2, . . . , 22-N (e.g., databases).

Each tier 12, 16 of the multi-tier system 10 further includes a local failure detection system. In particular, as shown in FIG. 1, the tier 12 includes a local failure detection system 24 that is coupled to each member 20-1, 20-2, . . . , 20-N of the component cluster 14. In accordance with the present invention, the local failure detection system 24 provides intra-tier failure detection using a heartbeating mechanism 26 that is specifically tuned to the members 20-1, 20-2, . . . , 20-N of the component cluster 14. To this extent, since the heartbeating mechanism 26 employed by the local failure detection system 24 only interacts with one component type, it can have, and utilize, detailed knowledge of the component to increase its effectiveness.

As further illustrated in FIG. 1, the tier 16 of the multi-tier system 10 also includes a local failure detection system 28 that is coupled to each member 22-1, 22-2, . . . , 22-N of the component cluster 18. The local failure detection system 28 provides intra-tier failure detection using a heartbeating mechanism 30 that is specifically tuned to the members 22-1, 22-2, . . . , 22-N of the component cluster 18. Again, since the heartbeating mechanism 30 employed by the local failure detection system 28 only interacts with one component type, it can have, and utilize, detailed knowledge of the component to increase its effectiveness.

Each tier 12, 16 further includes a central aggregation point comprising a high availability manager (HAM) 32, 34, respectively, for overseeing the operation of the local failure detection system 24, 28 in the tier. With regard to tier 12, for example, the HAM 32 is configured to obtain and report the failure status of the members 20-1, 20-2, . . . , 20-N of the component cluster 14, as provided by the local failure detection system 24, and to respond to application requests accordingly. Similarly, with regard to tier 16, the HAM 34 is configured to obtain and report the failure status of the members 22-1, 22-2, . . . , 22-N of the component cluster 18, as provided by the local failure detection system 28, and to respond to application requests accordingly. Although the HAMs 32, 34 are depicted in FIG. 1 as separate from the local failure detection system 24, 28, the functionality provided by the HAMs 32, 34 can be incorporated into the local failure detection system 24, 28 as indicated in phantom in FIG. 1.

A data connection 36 is provided between each HAM 32, 34. The location of the HAM 32 in the tier 12 is communicated to the tier 16, and the location of the HAM 34 in the tier 16 is provided to the tier 12. In general, in accordance with the present invention, the location of the HAM in each tier in a multi-tier system is communicated to the HAM in each other tier of the multi-tier system. This ensures that each HAM can provide component status information to each other HAM.

When a member 20-1, 20-2, . . . , 20-N of the component cluster 14 in the tier 12 is determined to have failed by the heartbeating mechanism 26 of the local failure detection system 24, the failure status of that member is communicated by the HAM 32 over the data connection 36 to the HAM 34 in the tier 16. The HAM 34 then communicates information regarding the failure to each member 22-1, 22-2, . . . , 22-N of the component cluster 18, which then take appropriate clean-up actions in response to the failure. Similarly, when a member 22-1, 22-2, . . . , 22-N of the component cluster 18 in the tier 16 is determined to have failed by the heartbeating mechanism 30 of the local failure detection system 28, the failure status of that member is communicated by the HAM 34 over the data connection 36 to the HAM 32 in the tier 14. The HAM 32 then communicates information regarding the failure to each member 20-1, 20-2, . . . , 20-N of the component cluster 14, which then take appropriate clean-up actions in response to the failure. To this extent, status changes (e.g., failure data) are communicated inter-tier via the data connection 36 only when needed.

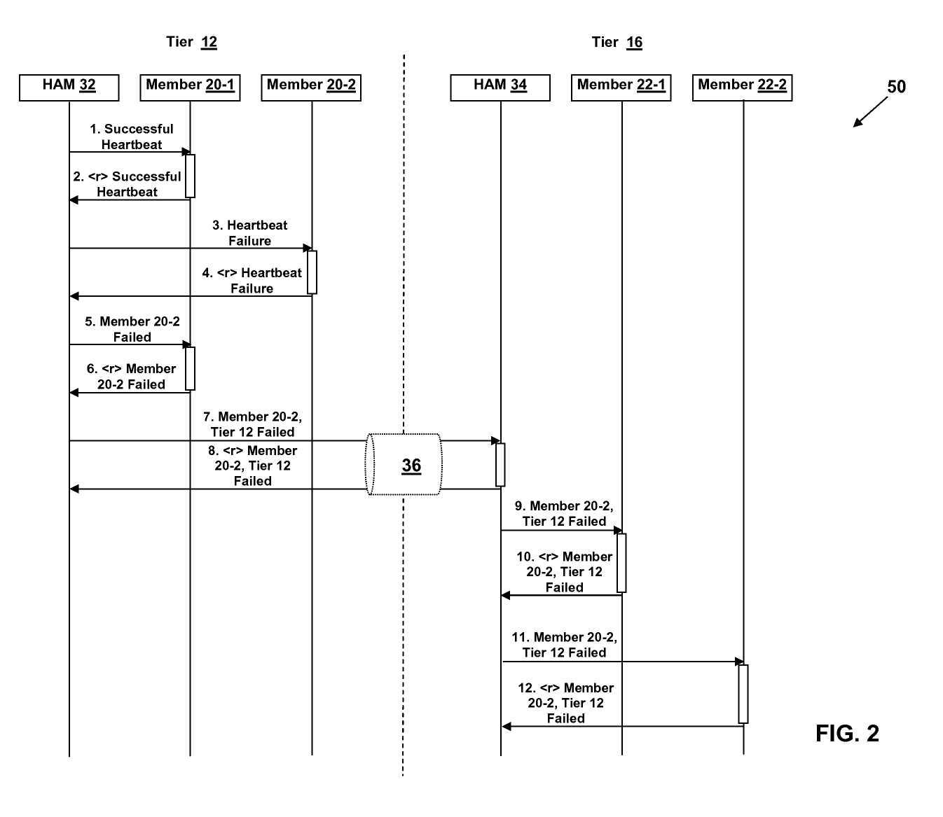

An illustrative sample runtime sequence 50 depicting the interaction of the components in FIG. 1 is shown in FIG. 2. In this example, the component cluster 14 in tier 12 includes a pair of members 20-1, 20-2, while the component cluster 18 in tier 16 includes a pair of members 22-1, 22-2. Further, it is assumed that the member 20-2 of the component cluster 14 in tier 12 has failed. The local failure detection systems 24, 28 in tiers 12, 16, respectively, are not shown for clarity. The sample runtime sequence 50 includes the following steps:
1 & 2: HAM 32 obtains successful heartbeat of member 20-1.
3 & 4: HAM 32 obtains heartbeat failure of member 20-2.
5 & 6: HAM 32 notifies member 20-1 of failure of member 20-2;
7 & 8: HAM 32 sends notification of failure of member 20-2 in tier 12 to HAM 34 of tier 16 via the data connection 36;
9 & 10: HAM 34 notifies member 22-1 of failure of member 20-2 in tier 12. Member 22-1 performs necessary clean-up actions.
11 & 12: HAM 34 notifies member 22-2 of failure of member 20-2 in tier 12. Member 22-2 performs necessary clean-up actions.

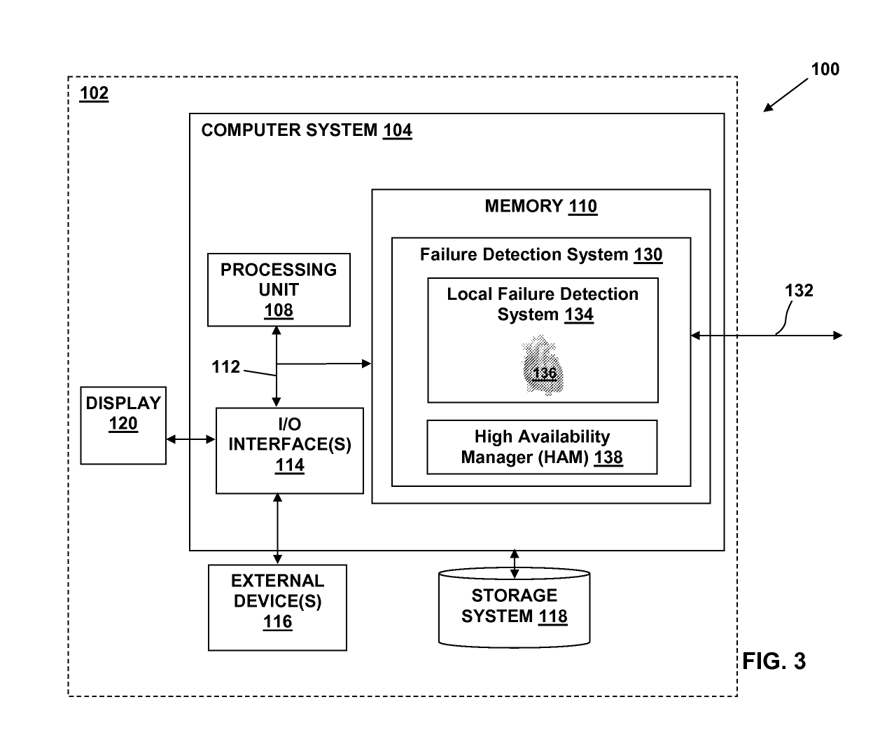

FIG. 3 shows an illustrative system 100 in accordance with embodiment(s) of the present invention. The system 100 includes a computer infrastructure 102 that can perform the various process steps described herein. In particular, the computer infrastructure 102 is shown as including a computer system 104 that comprises a failure detection system 130. The failure detection system 130 enables the computer system 104 to detect failures of the members of a component cluster in a tier of a multi-tier system (see, e.g., FIG. 1) and to communicate such failures to a failure detection system in another tier of the multi-tier system over a data connection 132.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as the failure detection system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The at least one external device 116 can comprise any device (e.g., display 120) that enables a user (not shown) to interact with the computer system 104 or any device that enables the computer system 104 to communicate with one or more other computer systems.

In any event, the computer system 104 can comprise any general purpose computing article of manufacture capable of executing computer program code installed by a user (e.g., a personal computer, server, handheld device, etc.). However, it is understood that the computer system 104 and the failure detection system 130 are only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the failure detection system 130 enables the computer system 104 to detect the failure of a member of a component cluster in a tier of a multi-tier system (see, e.g., FIG. 1) and to communicate the failure to the failure detection system in another tier of the multi-tier system over a data connection 132. The failure detection system 130 is shown as including a local failure detection system 134 that provides intra-tier failure detection using a heartbeating mechanism 136 that is specifically tuned to the members of the component cluster in the tier of the multi-tier system to which the failure detection system 130 belongs. Also provided is a high availability manager (HAM) 138 for overseeing the operation of the local failure detection system 134 and for communicating the failure status of a member over the data connection 132 to the HAM in another tier of the multi-tier system. Operation of each of these systems is discussed above.

It is understood that some of the various systems shown in FIG. 3 can be implemented independently, combined, and/or stored in memory for one or more separate computer systems 104 that communicate over a network. Further, it is understood that some of the systems and/or functionality may not be implemented, or additional systems and/or functionality may be included as part of the system 100.

While shown and described herein as a method and system for failure detection, it is understood that the invention further provides various alternative embodiments. For example, in one embodiment, the invention provides a computer-readable medium that includes computer program code to enable a computer infrastructure to provide failure detection. To this extent, the computer-readable medium includes program code, such as the failure detection system 130, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to provide failure detection as described above. In this case, the service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of failure detection. In this case, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

1. A method for failure detection, comprising:
performing intra-tier failure detection in a first tier of a multi-tier system;
providing a failure status to a central aggregation point in the first tier; and
communicating the failure status inter-tier to a central aggregation point of a second tier of the multi-tier system.

2. The method of claim 1, wherein performing intra-tier failure detection in the first tier of the multi-tier system further comprises:
performing heartbeating that is tuned to a plurality of members of a homogeneous component cluster in the first tier of the multi-tier system.

3. The method of claim 1, wherein the central aggregation point of the second tier of the multi-tier system communicates the failure status to a plurality of members of a homogeneous component cluster in the second tier of the multi-tier system.

4. The method of claim 1, further comprising:
performing intra-tier failure detection in the second tier of the multi-tier system;
providing a failure status to the central aggregation point in the second tier; and
communicating the failure status inter-tier to the central aggregation point of the first tier of the multi-tier system.

5. The method of claim 4, wherein performing intra-tier failure detection in the second tier of the multi-tier system further comprises:
performing heartbeating that is tuned to a plurality of members of a homogeneous component cluster in the second tier of the multi-tier system.

6. The method of claim 4, wherein the central aggregation point of the second tier of the multi-tier system communicates the failure status to the plurality of members of the homogeneous component cluster in the first tier of the multi-tier system.

7. A system for failure detection, comprising:
a system for performing intra-tier failure detection in a first tier of a multi-tier system;
a system for providing a failure status to a central aggregation point in the first tier; and
a system for communicating the failure status inter-tier to a central aggregation point of a second tier of the multi-tier system.

8. The system of claim 7, wherein the system for performing intra-tier failure detection in the first tier of the multi-tier system further comprises:
a system for performing heartbeating that is tuned to a plurality of members of a homogeneous component cluster in the first tier of the multi-tier system.

9. The system of claim 7, wherein the central aggregation point of the second tier of the multi-tier system includes a system for communicating the failure status to a plurality of members of a homogeneous component cluster in the second tier of the multi-tier system.

10. The system of claim 7, further comprising:
a system for performing intra-tier failure detection in the second tier of the multi-tier system;
a system for providing a failure status to the central aggregation point in the second tier; and
a system for communicating the failure status inter-tier to the central aggregation point of the first tier of the multi-tier system.

11. The system of claim 10, wherein the system for performing intra-tier failure detection in the second tier of the multi-tier system further comprises:
a system for performing heartbeating that is tuned to a plurality of members of a homogeneous component cluster in the second tier of the multi-tier system.

12. The system of claim 10, wherein the central aggregation point of the second tier of the multi-tier system includes a system for communicating the failure status to the plurality of members of the homogeneous component cluster in the first tier of the multi-tier system.

13. A program product stored on a computer readable medium for failure detection, the computer readable medium comprising program code for:
performing intra-tier failure detection in a first tier of a multi-tier system;
providing a failure status to a central aggregation point in the first tier; and
communicating the failure status inter-tier to a central aggregation point of a second tier of the multi-tier system.

14. The program product of claim 13, wherein the program code for performing intra-tier failure detection in the first tier of the multi-tier system further comprises program code for:
performing heartbeating that is tuned to a plurality of members of a homogeneous component cluster in the first tier of the multi-tier system.

15. The program product of claim 13, further comprising program code for communicating the failure status from the central aggregation point of the second tier of the multi-tier system to a plurality of members of a homogeneous component cluster in the second tier of the multi-tier system.

16. The program product of claim 13, further comprising program code for:
performing intra-tier failure detection in the second tier of the multi-tier system;
providing a failure status to the central aggregation point in the second tier; and
communicating the failure status inter-tier to the central aggregation point of the first tier of the multi-tier system.

17. The program product of claim 16, wherein the program code for performing intra-tier failure detection in the second tier of the multi-tier system further comprises program code for:
performing heartbeating that is tuned to a plurality of members of a homogeneous component cluster in the second tier of the multi-tier system.

18. The program product of claim 16, further comprising program code for communicating the failure status from the central aggregation point of the second tier of the multi-tier system to the plurality of members of the homogeneous component cluster in the first tier of the multi-tier system.
